(19) United States
(12) Patent Application Publication
(10) Pub. No.: US 2009/0052697 A1
(43) Pub. Date: Feb. 26, 2009

(54) Communication Device

(75) Inventors: Fu-Hsiang Liu, Taipei (TW); Zhih-Pei Shih, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/181,066

(22) Filed: Jul. 28, 2008

(30) Foreign Application Priority Data
Aug. 21, 2007 (TW) 96130947

(51) Int. Cl. H02B 1/00

(52) U.S. Cl. 381/123

(57) ABSTRACT

A communication device includes a body and a sound receiving device. One end of the sound receiving device is pivotally connected to the body. The sound receiving device includes an omni-directional microphone and a uni-directional microphone. A processor has two modes for starting and operating the omni-directional microphone and the unidirectional microphone, respectively. An angle detecting element is located at the body to measure a rotary angle of the sound receiving device relative to the body, and then the processor switches to one of the two modes according to the rotary angle further to start the omni-directional microphone or the unidirectional microphone.

### RELATED APPLICATIONS

This application claims priority to Taiwan Application Serial Number 96130947, filed Aug. 21, 2007, which is herein incorporated by reference.

### BACKGROUND OF THE INVENTION

1. Field of the Invention

The invention relates to a communication device and, more particularly, to a communication device with a function of automatically switching between different microphones.

2. Description of the Related Art

A communication device with a speaker function utilizes its loudspeaker and microphone to allow conventioneers or persons who are communicating with each other not to hold receivers. This type of communication devices generally needs a good sound receiving function. For example, they sometimes need to receive sounds of the conventioneers from all directions or sometimes need to receive the sound of a specific person to meet with various sound receiving requirements in a conference. Many aspects need to be improved to make the sound receiving function of this type of communication devices be the best.

### BRIEF SUMMARY OF THE INVENTION

The objective of the invention is to provide a communication device with a function of automatically switching between different microphones.

To achieve the above objective, the invention provides a communication device including a body and a sound receiving device. One end of the sound receiving device is pivotally connected to the body. The sound receiving device includes an omni-directional microphone and a uni-directional microphone. A processor has two modes for starting and operating the omni-directional microphone and the uni-directional microphone, respectively. An angle detecting element is located at the body and is used for measuring a rotary angle of the sound receiving device relative to the body, and then the processor switches to one of the two modes according to the rotary angle further to start the omni-directional microphone or the uni-directional microphone.

To achieve the above objective, the invention provides another communication device including a body and a sound receiving device. One end of the sound receiving device is pivotally connected to the body. The sound receiving device includes an omni-directional microphone, a uni-directional microphone and a first angle detecting element. A processor has two modes for starting and operating the omni-directional microphone and the uni-directional microphone, respectively. A second angle detecting element is located at the body, and the first angle detecting element and the second angle detecting element are used for measuring a rotary angle of the sound receiving device relative to the body. Then, the processor switches to one of the two modes further to start the omni-directional microphone or the uni-directional microphone.

### BRIEF DESCRIPTION OF THE SEVERAL VIEWS OF THE DRAWINGS

These and other features, aspects, and advantages of the invention will become better understood with regard to the following description and accompanying drawings.

FIG. 1 is a schematic diagram showing a communication device according to one embodiment of the invention;

FIG. 2 is a lateral view showing the communication device (a sound receiving device is attached to a body) in FIG. 1;

FIG. 3 is a lateral view showing the communication device (the sound receiving device is away from the body) in FIG. 1; and

FIG. 4 is a block diagram showing a communication device according to one embodiment of the invention.

### DETAILED DESCRIPTION OF THE EMBODIMENTS

From the above, the invention provides a communication device. The sound receiving device of the communication device has an omni-directional microphone and a uni-directional microphone, and the omni-directional microphone or the uni-directional microphone is used according to the relative position relationship between the sound receiving device and the body of the communication device. The communication device is illustrated in detail in the following embodiment.

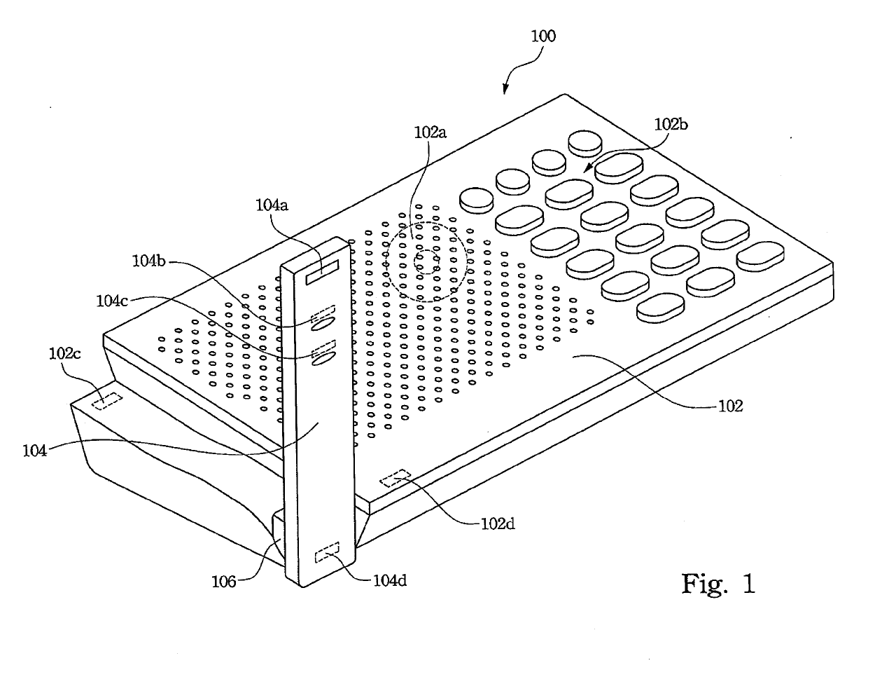

FIG. 1 is a schematic diagram showing a communication device according to one embodiment of the invention. A communication device 100 includes a body 102 and a sound receiving device 104. The body 102 has a loudspeaker 102a for amplifying sounds, and a key portion 102b is disposed at the upper surface of the body 102 for a user to operate. The sound receiving device 104 is pivotally connected to the body 102 via a rotating shaft 106, and therefore, the sound receiving device 104 can be rotated relatively to the body 102 to a needed position. The communication device 100 may be a telephone or a conference communication device.

To allow the communication device 100 to meet requirements for receiving sounds under different conditions, the sound receiving device 104 is provided with an omni-directional microphone 104b and a uni-directional microphone 104c for receiving external sound sources via sound receiving holes of the sound receiving device 104. In the embodiment, when the sound receiving device 104 is attached to the body 102, the omni-directional microphone 104b is used to receive the external sound source from each direction. When the sound receiving device 104 is away from the body 102, the uni-directional microphone 104c is used to receive the external source of a specific direction (such as a direction which is perpendicular to the sound receiving holes).

As shown in FIG. 1 to FIG. 3, the communication device 100 senses a rotary position of the sound receiving device 104 relative to the body 102 via angle detecting elements (such as a magnetic element and a magnetism sensing element) disposed at the body 102 and the sound receiving device 104 to switch to one of the omni-directional microphone 104b and the uni-directional microphone 104c. Positions of the magnetic element and the magnetism sensing element on the communication device 100 can be changed to meet with different requirements.

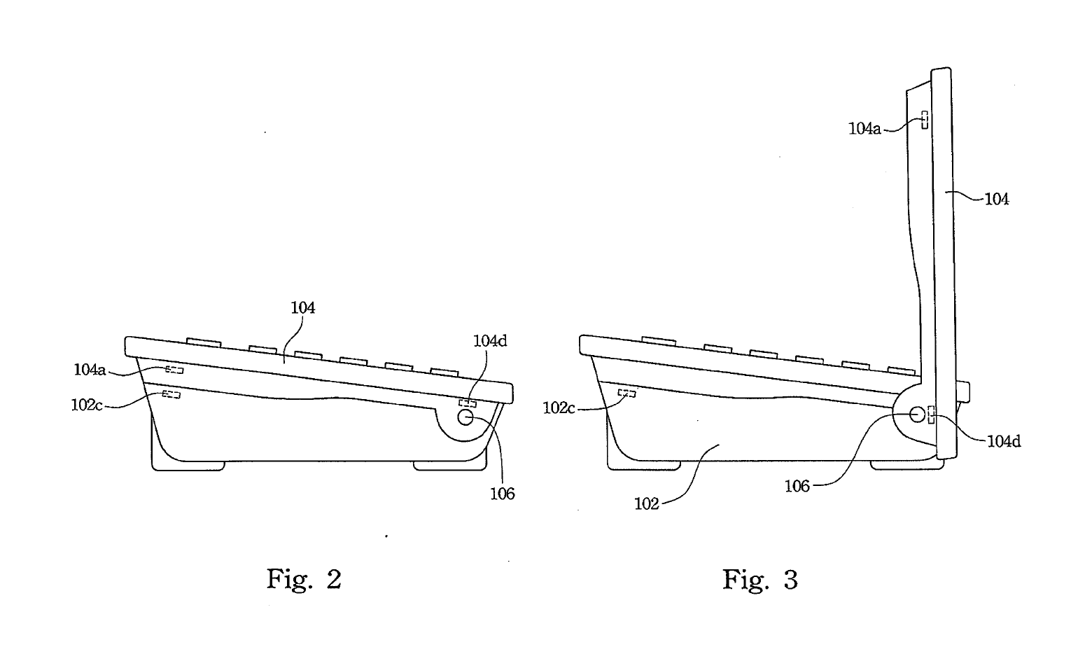

In one of the embodiments, when a magnetic element 104a is disposed at one end of the sound receiving device 104, a magnetism sensing element 102c is disposed at a corresponding position. When the sound receiving device 104 is attached to the body 102 (as shown in FIG. 2, that is, the rotary angle is zero degrees), the magnetism sensing element 102c senses a great magnetic flux of the magnetic element 104a, and then the omni-directional microphone 104b is started to receive sounds. When the sound receiving device 104 rotates to be away from the body 102 or be perpendicular to the body 102 (as shown in FIG. 3, that is, the rotary angle is seventy degrees to one hundred and ten degrees), compared with the state in FIG. 2, the magnetism sensing element 102c senses a less magnetic flux of the magnetic element 104a, and then the uni-directional microphone 104c is started to receive sounds.

In another embodiment, when the magnetic element 104d is disposed at one end where the sound receiving device 104 is pivotally connected to the body 102, the magnetism sensing element 102d is also disposed at a corresponding position (corresponding to the position where the body 102 is pivotally connected to the sound receiving device 104). When the sound receiving device 104 is attached to the body 102 (as shown in FIG. 2, that is, the rotary angle is zero degrees), the magnetism sensing element 102d senses a first magnetic flux of the magnetic element 104d, and then the omni-directional microphone 104b is started to receive sounds. When the sound receiving device 104 rotates to be away from the body 102 or be perpendicular to the body 102 (as shown in FIG. 3, that is, the rotary angle is about seventy degrees to one hundred and ten degrees), the magnetism sensing element 102d senses a second magnetic flux of the magnetic element 104d (different from the first magnetic flux), and then the uni-directional microphone 104c is started to receive sounds.

In another embodiment, the magnetic element and the magnetism sensing element in the above embodiment may be interchanged with each other. For example, the magnetic element 104d and the magnetism sensing element 102d may be interchanged with each other; the magnetic element 104a and the magnetism sensing element 102c may be interchanged with each other to achieve the objective of the invention.

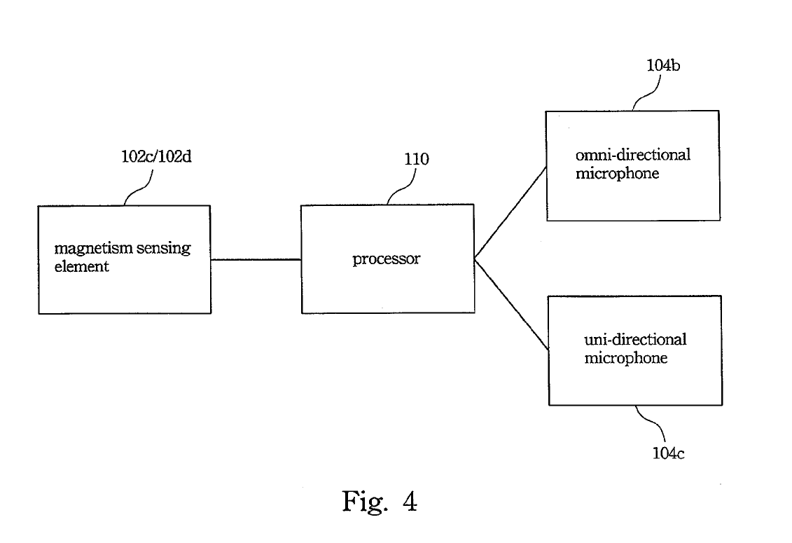

FIG. 4 is a block diagram showing a communication device according to one embodiment of the invention. When the omni-directional microphone 104b or the uni-directional microphone 104c is used to receive sounds, the needed operation mode is controlled by the processor 110. The processor 110 is in charge of suppressing interference between the microphone and the loudspeaker. The magnetism sensing element 102c or 102d senses the rotary position of the magnetic element 104a or 104d relative to the magnetism sensing element 102c or 102d to allow the processor 110 to switch to one of the two modes further to start the omni-directional microphone 104b or the uni-directional microphone 104c.

According to the above preferred embodiment of the invention, a communication device using the invention can automatically determine to use an omni-directional microphone or a uni-directional microphone when the position of a sound receiving device relative to the body of the communication device is changed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A communication device comprising:
a body;
a sound receiving device one end of which is pivotally connected to the body, wherein the sound receiving device comprises an omni-directional microphone and a uni-directional microphone;
a processor having two modes for starting and operating the omni-directional microphone and the uni-directional microphone, respectively; and
an angle detecting element which is located at the body and is used for measuring a rotary angle of the sound receiving device relative to the body to allow the processor to switch to one of the two modes according to the rotary angle further to start the omni-directional microphone or the uni-directional microphone.

2. The communication device according to claim 1, wherein when the sound receiving device is attached to the body, the rotary angle is zero degrees, and the processor starts the omni-directional microphone.

3. The communication device according to claim 1, wherein when the sound receiving device is rotated to be away from the body, the processor starts the uni-directional microphone.

4. The communication device according to claim 1, wherein when the sound receiving device is approximately perpendicular to the body, that is, the rotary angle is seventy degrees to one hundred and ten degrees, the processor switches to the mode of operating the uni-directional microphone.

5. The communication device according to claim 1, wherein the angle detecting element is located at a position where the body is pivotally connected to the sound receiving device.

6. A communication device comprising:
a body;
a sound receiving device one end of which is pivotally connected to the body, wherein the sound receiving device comprises an omni-directional microphone, a uni-directional microphone and a first angle detecting element;
a processor having two modes for starting and operating the omni-directional microphone and the uni-directional microphone, respectively; and
a second angle detecting element which is located at the body, wherein the first angle detecting element and the second angle detecting element are used for measuring a rotary angle of the sound receiving device relative to the body to allow the processor to switch to one of the two modes further to start the omni-directional microphone or the uni-directional microphone.

7. The communication device according to claim 6, wherein the first angle detecting element is a magnetic element, and the second angle detecting element is a magnetism sensing element.

8. The communication device according to claim 7, wherein the magnetism sensing element is a Hall effect sensor.

9. The communication device according to claim 6, wherein the first angle detecting element is a magnetism sensing element, and the second angle detecting element is a magnetic element.

10. The communication device according to claim 9, wherein the magnetism sensing element is a Hall effect sensor.

11. The communication device according to claim 6, wherein when the sound receiving device is attached to the body, the rotary angle is zero degrees, and the processor starts the omni-directional microphone.

12. The communication device according to claim 6, wherein when the sound receiving device is rotated to be away from the body, the processor starts the uni-directional microphone.

13. The communication device according to claim 6, wherein when the sound receiving device is approximately perpendicular to the body, that is, the rotary angle is seventy degrees to one hundred and ten degrees, the processor switches to the mode of operating the uni-directional microphone.

14. The communication device according to claim 6, wherein the second angle detecting element is located at a position where the body is pivotally connected to the sound receiving device.

15. The communication device according to claim 6, wherein the first angle detecting element is located at one end where the body is pivotally connected to the sound receiving device.

16. The communication device according to claim 6, wherein the first angle detecting element is located at another end opposite to the end where the body is pivotally connected to the sound receiving device.
